(19) United States
(12) Patent Application Publication
(10) Pub. No.: US 2024/0282526 A1
(43) Pub. Date: Aug. 22, 2024

(54) WOUND CAPACITOR PACKAGE STRUCTURE AND SEALING ELEMENT THEREOF

(71) Applicant: APAQ TECHNOLOGY CO., LTD., Miaoli County (TW)

(72) Inventors: CHUNG-JUI SU, KAOHSIUNG CITY (TW); CHENG-HAO LU, MIAOLI COUNTY (TW)

(21) Appl. No.: 18/476,330

(22) Filed: Sep. 28, 2023

(30) Foreign Application Priority Data
Feb. 17, 2023 (TW) 112105658

(51) Int. Cl. H01G 4/224; H01G 4/32

(52) U.S. Cl. CPC H01G 4/224; H01G 4/32

(57) ABSTRACT

A wound capacitor package structure and a sealing element thereof are provided. The wound capacitor package structure includes a wound assembly, a conductive assembly, a package casing and a sealing element. The conductive assembly includes a first conductive pin and a second conductive pin. The package casing is configured to receive the wound assembly. The sealing element is disposed inside the package casing and cooperating with the package casing, and the sealing element is configured to prevent the wound assembly from contacting an external environment. The package casing has a surrounding concave position-limiting portion recessed inward to press the sealing element, and a surrounding convex end portion protruding from the surrounding concave position-limiting portion to abut against the sealing element. The sealing element includes an elastomeric seal structure pressed by the surrounding concave position-limiting portion, and an oleophobic structure for protecting the elastomeric seal structure.

### CROSS-REFERENCE TO RELATED PATENT APPLICATION

This application claims the benefit of priority to Taiwan Patent Application No. 112105658, filed on Feb. 17, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor package structure and a sealing element thereof, and more particularly to a wound capacitor package structure and a sealing element thereof.

### BACKGROUND OF THE DISCLOSURE

Various applications of capacitors include being used in home appliances, computer motherboards and peripherals, power supplies, communication products and automobiles. Capacitors such as solid electrolytic capacitors are mainly used to provide functions such as filtering, bypassing, rectifying, coupling, blocking and transforming. However, there is still room for improvement in the related art of the capacitor.

### SUMMARY OF THE DISCLOSURE

In response to the above-referenced technical inadequacy, the present disclosure provides a wound capacitor package structure and a sealing element thereof for reducing the corrosiveness of the elastomeric seal structure by an oil-containing cooling liquid.

In order to solve the above-mentioned problems, one of the technical aspects adopted by the present disclosure is to provide a wound capacitor package structure, which includes a wound assembly, a conductive assembly, a package casing and a sealing element. The wound assembly includes a wound positive conductive foil, a wound negative conductive foil and two wound insulating separators. The conductive assembly includes a first conductive pin electrically contacting the wound positive conductive foil and a second conductive pin electrically contacting the wound negative conductive foil. The package casing is configured to receive the wound assembly. The sealing element is disposed inside the package casing and cooperating with the package casing, and the sealing element is configured to prevent the wound assembly from contacting an external environment. One of the two wound insulating separators is disposed between the wound positive conductive foil and the wound negative conductive foil, and one of the wound positive conductive foil and the wound negative conductive foil is disposed between the two wound insulating separators. The first conductive pin includes a first embedded portion accommodated inside the package casing and enclosed by the sealing element, and a first exposed portion exposed outside the package casing, and the second conductive pin includes a second embedded portion accommodated inside the package casing and enclosed by the sealing element, and a second exposed portion exposed outside the package casing. The package casing has a surrounding concave position-limiting portion recessed inward to press the sealing element, and a surrounding convex end portion protruding from the surrounding concave position-limiting portion to abut against the sealing element. The sealing element includes an elastomeric seal structure pressed by the surrounding concave position-limiting portion, and an oleophobic structure for protecting the elastomeric seal structure, and the oleophobic structure of the sealing element is configured to reduce the corrosiveness of the elastomeric seal structure by an oil-containing cooling liquid.

In order to solve the above-mentioned problems, another one of the technical aspects adopted by the present disclosure is to provide a wound capacitor package structure, which includes a wound assembly, a conductive assembly, a package casing and a sealing element. The conductive assembly includes a first conductive pin and a second conductive pin. The package casing is configured to receive the wound assembly. The sealing element is disposed inside the package casing and cooperating with the package casing, and the sealing element is configured to prevent the wound assembly from contacting an external environment. The package casing has a surrounding concave position-limiting portion recessed inward to press the sealing element, and a surrounding convex end portion protruding from the surrounding concave position-limiting portion to abut against the sealing element. The sealing element includes an elastomeric seal structure pressed by the surrounding concave position-limiting portion, and an oleophobic structure for protecting the elastomeric seal structure, and the oleophobic structure of the sealing element is configured to reduce the corrosiveness of the elastomeric seal structure by an oil-containing cooling liquid.

In order to solve the above-mentioned problems, yet another one of the technical aspects adopted by the present disclosure is to provide a sealing element applied to a wound capacitor package structure including a wound assembly, a conductive assembly and a package casing. The sealing element is disposed inside the package casing and cooperating with the package casing, and the sealing element is configured to prevent the wound assembly from contacting an external environment. The package casing has a surrounding concave position-limiting portion recessed inward to press the sealing element, and a surrounding convex end portion protruding from the surrounding concave position-limiting portion to abut against the sealing element. The sealing element includes an elastomeric seal structure pressed by the surrounding concave position-limiting portion, and an oleophobic structure for protecting the elastomeric seal structure, and the oleophobic structure of the sealing element is configured to reduce the corrosiveness of the elastomeric seal structure by an oil-containing cooling liquid.

In one of the possible or preferred embodiments, the package casing has an opening, and the sealing element is configured to be disposed at the opening of the package casing so as to close the opening of the package casing.

In one of the possible or preferred embodiments, the elastomeric seal structure has an upper surface facing away from the wound assembly, a lower surface facing the wound assembly, and an outer surrounding surface connected between the upper surface and the lower surface, and the oleophobic structure includes an oleophobic structural layer containing a predetermined oil-resistant material.

In one of the possible or preferred embodiments, when the upper surface, the lower surface and the outer surrounding surface of the elastomeric seal structure are covered by the oleophobic structural layer, the elastomeric seal structure is completely covered by the oleophobic structural layer, thereby preventing the upper surface, the lower surface and the outer surrounding surface of the elastomeric seal structure from contacting the oil-containing cooling liquid.

In one of the possible or preferred embodiments, when the upper surface and the outer surrounding surface of the elastomeric seal structure are covered by the oleophobic structural layer, the elastomeric seal structure is partially covered by the oleophobic structural layer, thereby preventing both the upper surface and the outer surrounding surface of the elastomeric seal structure from contacting the oil-containing cooling liquid.

In one of the possible or preferred embodiments, when the upper surface of the elastomeric seal structure is covered by the oleophobic structural layer, the elastomeric seal structure is partially covered by the oleophobic structural layer, thereby preventing the upper surface of the elastomeric seal structure from contacting the oil-containing cooling liquid.

In one of the possible or preferred embodiments, before the sealing element is pressed by the surrounding concave position-limiting portion, the elastomeric seal structure of the sealing element has an outer surrounding concave portion, the outer surrounding concave portion of the elastomeric seal structure has an outer surrounding concave space configured to accommodate a part of the surrounding concave position-limiting portion, and a concave contour of the outer surrounding concave portion of the elastomeric seal structure and a concave contour of the surrounding concave position-limiting portion of the package casing correspond to each other.

In one of the possible or preferred embodiments, after the sealing element is pressed by the surrounding concave position-limiting portion, a large part of the outer surrounding concave portion of the elastomeric seal structure is uniformly pressed by the surrounding concave position-limiting portion, so that an outer peripheral area of the outer surrounding concave portion of the elastomeric seal structure has an approximate amount of deformation.

In one of the possible or preferred embodiments, before the sealing element is pressed by the surrounding concave position-limiting portion, the elastomeric seal structure of the sealing element has an outer surrounding plane portion, and the outer surrounding plane portion of the elastomeric seal structure has an outer surrounding plane configured to correspond to the surrounding concave position-limiting portion.

In one of the possible or preferred embodiments, the oleophobic structure includes a plurality of oleophobic fillers each containing a predetermined oil-resistant material, and the oleophobic fillers are mixed into the elastomeric seal structure so as to form the sealing element having an oleophobic function.

In one of the possible or preferred embodiments, the predetermined oil-resistant material includes polyurethane rubber, acrylate rubber, fluoro rubber or nitrile rubber, the fluoro rubber is chlorohydrin rubber, fluorosilicone rubber or fluoro-phosphazene rubber, and the nitrile rubber is hydrogenated nitrile rubber.

Therefore, in the wound capacitor package structure and the sealing element thereof provided by the present disclosure, by virtue of “the sealing element being disposed inside the package casing and cooperating with the package casing, and the sealing element being configured to prevent the wound assembly from contacting an external environment” and “the sealing element including an elastomeric seal structure pressed by the surrounding concave position-limiting portion, and an oleophobic structure for protecting the elastomeric seal structure,” the oleophobic structure of the sealing element can be configured to reduce the corrosiveness of the elastomeric seal structure by an oil-containing cooling liquid.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of the cooperation between the wound assembly and the conductive assembly of the wound capacitor package structure provided by a first embodiment of the present disclosure;

FIG. 2 is a partial schematic cross-sectional view of the wound capacitor package structure provided by the first embodiment of the present disclosure before the conductive assembly passes through the sealing element;

FIG. 3 is a partial schematic cross-sectional view of the wound assembly and the sealing element of the wound capacitor package structure provided by the first embodiment of the present disclosure after the wound assembly and the sealing element are put into the package casing;

FIG. 4 is a partial schematic cross-sectional view of the wound capacitor package structure provided by the first embodiment of the present disclosure;

FIG. 5 is a schematic enlarged view of part V of FIG. 4;

FIG. 6 is a schematic view of the wound capacitor package structure provided by the first embodiment of the present disclosure immersed in an oil-containing cooling liquid;

FIG. 7 is a partial schematic cross-sectional view of the wound capacitor package structure provided by a second embodiment of the present disclosure before the conductive assembly passes through the sealing element;

FIG. 8 is a partial schematic cross-sectional view of the wound capacitor package structure provided by a third embodiment of the present disclosure before the conductive assembly passes through the sealing element;

FIG. 9 is a partial schematic cross-sectional view of the wound capacitor package structure provided by a fourth embodiment of the present disclosure before the conductive assembly passes through the sealing element;

FIG. 10 is a partial schematic cross-sectional view of the wound capacitor package structure provided by a fifth embodiment of the present disclosure before the conductive assembly passes through the sealing element;

FIG. 11 is a partial schematic cross-sectional view of the wound capacitor package structure provided by a sixth embodiment of the present disclosure before the conductive assembly passes through the sealing element;

FIG. 12 is a partial schematic cross-sectional view of the wound capacitor package structure provided by a seventh embodiment of the present disclosure before the conductive assembly passes through the sealing element; and

FIG. 13 is a partial schematic cross-sectional view of the wound capacitor package structure provided by an eighth embodiment of the present disclosure before the conductive assembly passes through the sealing element.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

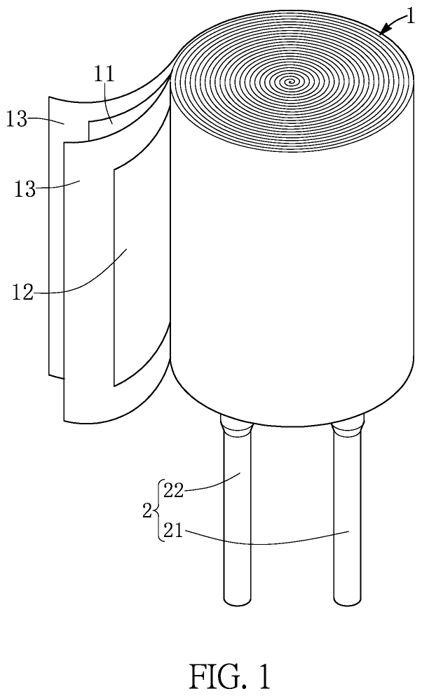

Referring to FIG. 1 to FIG. 6, a first embodiment of the present disclosure provides a method of manufacturing a wound capacitor package structure P (i.e., a winding-type capacitor package structure), which includes a wound assembly 1, a conductive assembly 2, a package casing 3 (or an encapsulating casing) and a sealing element 4 (or a sealing component).

Firstly, as shown in FIG. 1, the wound assembly 1 includes a wound positive conductive foil 11, a wound negative conductive foil 12 and two wound insulating separators 13. More particularly, one of the two wound insulating separators 13 can be disposed between the wound positive conductive foil 11 and the wound negative conductive foil 12, and one of the wound positive conductive foil 11 and the wound negative conductive foil 12 is disposed between the two wound insulating separators 13 (for example, as shown in FIG. 1, the wound positive conductive foil 11 is disposed between the two wound insulating separators 13). In addition, the wound insulating separator 13 can be an insulating paper or insulating foil containing a dipping material such as a conductive polymer. However, the aforementioned details are disclosed for exemplary purposes only, and are not meant to limit the scope of the present disclosure.

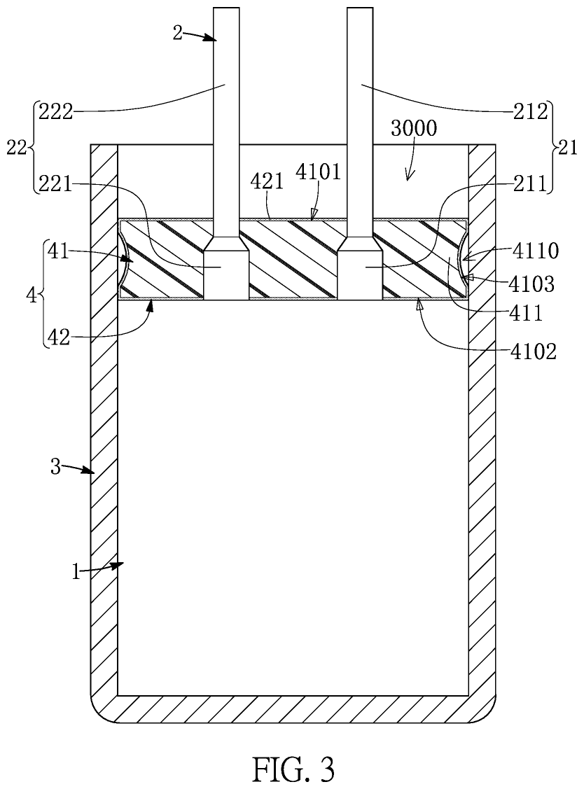

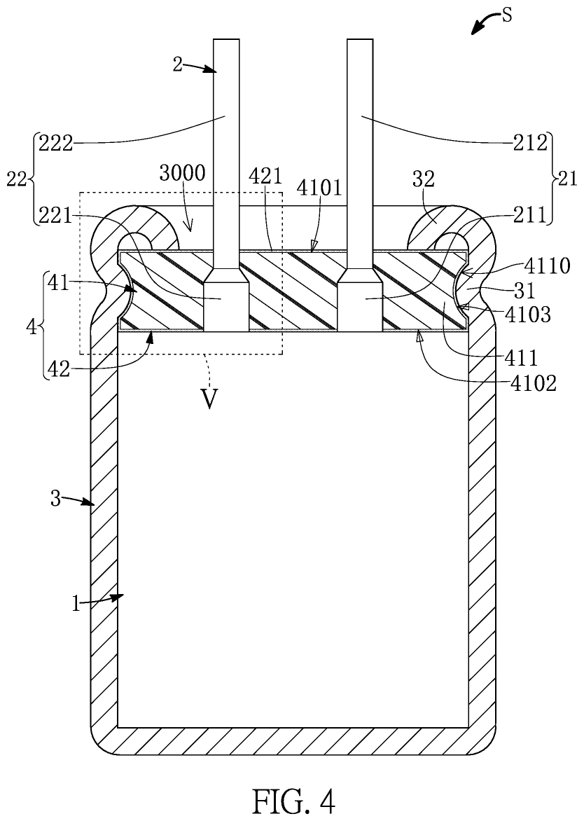

Furthermore, referring to FIG. 3 and FIG. 4, the conductive assembly 2 includes a first conductive pin 21 electrically contacting the wound positive conductive foil 11 and a second conductive pin 22 electrically contacting the wound negative conductive foil 12. For example, the first conductive pin 21 includes a first embedded portion 211 accommodated inside the package casing 3 and enclosed by the sealing element 4, and a first exposed portion 212 exposed outside or from the package casing 3, and the second conductive pin 22 includes a second embedded portion 221 accommodated inside the package casing 3 and enclosed by the sealing element 4, and a second exposed portion 222 exposed outside or from the package casing 3. However, the aforementioned details are disclosed for exemplary purposes only, and are not meant to limit the scope of the present disclosure.

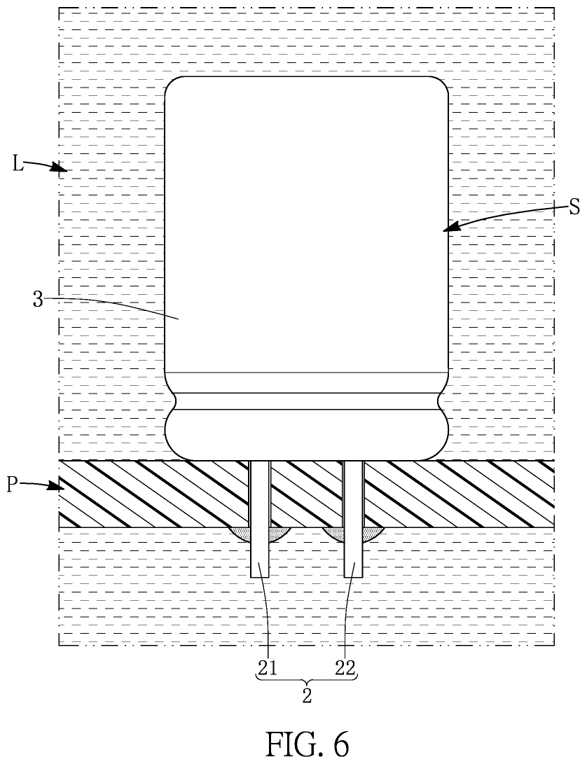

Moreover, referring to FIG. 3, FIG. 4 and FIG. 6, the package casing 3 can be configured to receive the wound assembly 1, and the sealing element 4 can be disposed inside the package casing 3 and cooperate with the package casing 3, and the sealing element 4 can be configured to prevent the wound assembly 1 from contacting an external environment (or the sealing element 4 can be configured as a barrier to avoid contact between the wound assembly 1 and the external environment). For example, referring to FIG. 3 and FIG. 4, the package casing 3 has an opening 3000, and the sealing element 4 can be disposed at the opening 3000 of the package casing 3 so as to close (or completely cover) the opening 3000 of the package casing 3. As shown in FIG. 4, after the sealing element 4 is pressed by the package casing 3, the package casing 3 has a surrounding concave position-limiting portion 31 that is recessed inward to press the sealing element 4, and a surrounding convex end portion 32 that is protruding from the surrounding concave position-limiting portion 31 to abut against the sealing element 4. In addition, the sealing element 4 includes an elastomeric seal structure 41 (or an elastic seal structure) pressed by the surrounding concave position-limiting portion 31, and an oleophobic structure 42 for protecting the elastomeric seal structure 41. As shown in FIG. 6, when the wound capacitor package structure S that is soldered on a circuit substrate P is immersed in an oil-containing cooling liquid L (such as any oily cooling liquid or any cooling liquid that can be used in immersion cooling technology), the oleophobic structure 42 of the sealing element 4 can be configured to reduce the corrosiveness of the elastomeric seal structure 41 by the oil-containing cooling liquid L. However, the aforementioned details are disclosed for exemplary purposes only, and are not meant to limit the scope of the present disclosure.

It should be noted that referring to FIG. 3, FIG. 4 and FIG. 6, the elastomeric seal structure 41 has an upper surface 4101 facing away from the wound assembly 1, a lower surface 4102 facing the wound assembly 1, and an outer surrounding surface 4103 connected between the upper surface 4101 and the lower surface 4102, and the oleophobic structure 42 includes an oleophobic structural layer 421 containing a predetermined oil-resistant material. Therefore, when the upper surface 4101, the lower surface 4102 and the outer surrounding surface 4103 of the elastomeric seal structure 41 are covered by the oleophobic structural layer 421, the elastomeric seal structure 41 can be completely covered or enclosed by the oleophobic structural layer 421, thereby preventing the upper surface 4101, the lower surface 4102 and the outer surrounding surface 4103 of the elastomeric seal structure 41 from contacting the oil-containing cooling liquid L so as to reduce the corrosiveness of the elastomeric seal structure 41 by the oil-containing cooling liquid L.

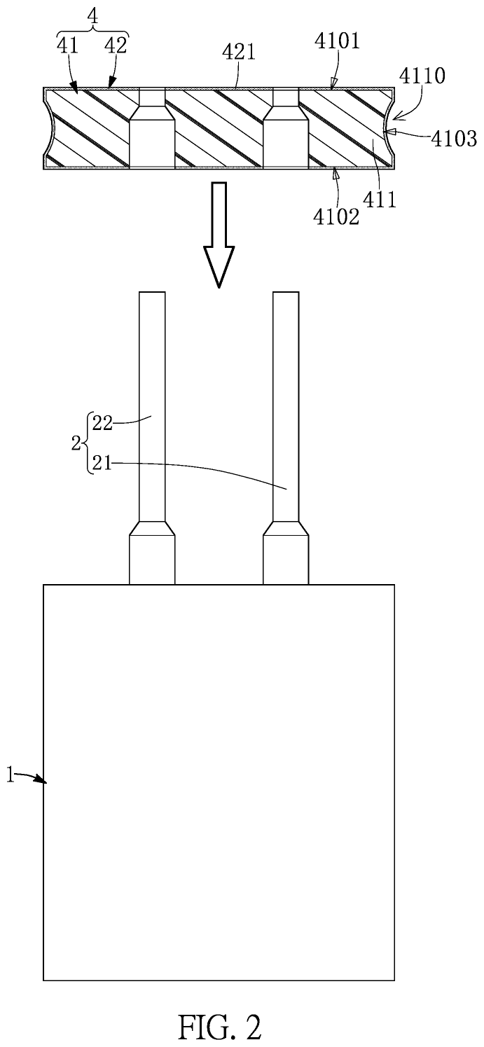

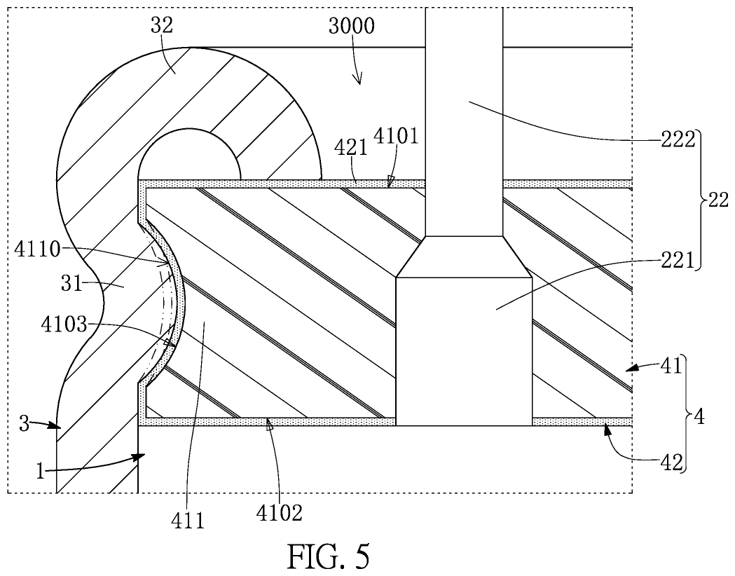

It should be noted that referring to FIG. 2 and FIG. 3, before the sealing element 4 is pressed by the surrounding concave position-limiting portion 31, the elastomeric seal structure 41 of the sealing element 4 has an outer surrounding concave portion 411, the outer surrounding concave portion 411 of the elastomeric seal structure 41 has an outer surrounding concave space 4110 configured to accommodate a part of the surrounding concave position-limiting portion 31, and a concave contour of the outer surrounding concave portion 411 of the elastomeric seal structure 41 and a concave contour of the surrounding concave position-limiting portion 31 of the package casing 3 correspond to (such as coincide with or are similar to) each other. Moreover, referring to FIG. 4 and FIG. 5, after the sealing element 4 is pressed by the surrounding concave position-limiting portion 31, a large part of the outer surrounding concave portion 411 of the elastomeric seal structure 41 is uniformly and surroundingly pressed by the surrounding concave position-limiting portion 31, so that an outer peripheral area of the outer surrounding concave portion 411 of the elastomeric seal structure 41 has an approximate amount of deformation. That is to say, since the elastomeric seal structure 41 can provide an outer surrounding concave portion 411 in advance, when the outer surrounding concave portion 411 of the sealing element 4 is pressed by the surrounding concave position-limiting portion 31 of the package casing 3, the outer surrounding concave portion 411 of the elastomeric seal structure 41 will not have too much deformation (i.e., the amount of change from the dotted line to the solid line as shown in FIG. 5, that is a very small amount of arc change), thereby avoiding structural damage to the outer surrounding concave portion 411 and avoiding reducing the sealing effect between the package casing 3 and the sealing element 4, and thereby lowering the structural damage (such as pin offset or pin bending) that may occur when the first conductive pin 21 and the second conductive pin 22 of the conductive assembly 2 are pressed by the surrounding concave position-limiting portion 31 of the package casing 3.

For example, the predetermined oil-resistant material may include polyurethane rubber (or urethane rubber), acrylate rubber, fluoro rubber or nitrile rubber, or any material with oleophobic properties. Moreover, the fluoro rubber can be chlorohydrin rubber (or epichlorohydrin rubber), fluorosilicone rubber or fluoro-phosphazene rubber, and the nitrile rubber can be hydrogenated nitrile rubber. However, the aforementioned details are disclosed for exemplary purposes only, and are not meant to limit the scope of the present disclosure.

### Second Embodiment

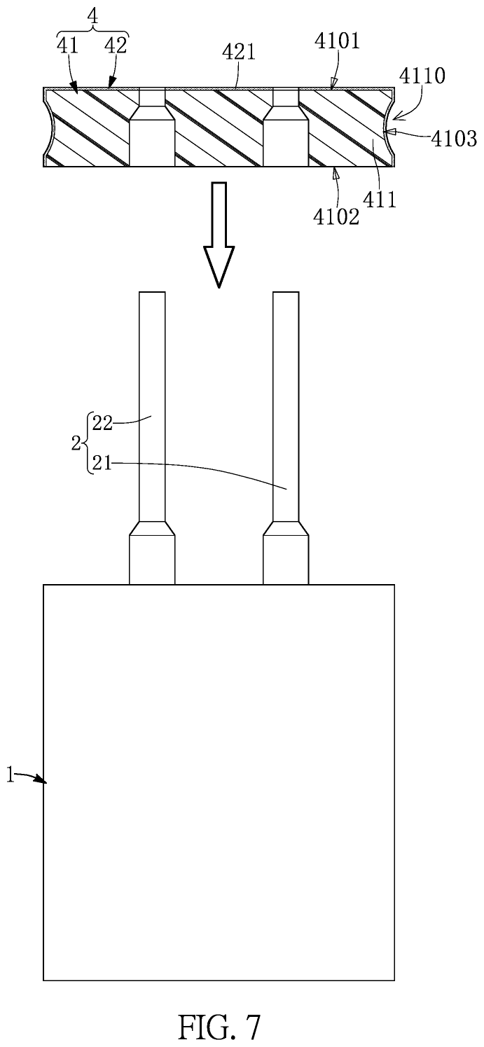

Referring to FIG. 7, a second embodiment of the present disclosure provides a sealing element 4 that can be applied to a wound capacitor package structure (not shown, but referring to the first embodiment). Comparing FIG. 7 with FIG. 2, the main difference between the second embodiment and the first embodiment is as follows: in the second embodiment, before the sealing element 4 is pressed by the surrounding concave position-limiting portion (not shown, but referring to the first embodiment), only the upper surface 4101 and the outer surrounding surface 4103 of the elastomeric seal structure 41 are covered by the oleophobic structural layer 421, so that the elastomeric seal structure 41 can be partially covered by the oleophobic structural layer 421, thereby preventing both the upper surface 4101 and the outer surrounding surface 4103 of the elastomeric seal structure 41 from contacting the oil-containing cooling liquid L so as to reduce the corrosiveness of the elastomeric seal structure 41 by the oil-containing cooling liquid L.

### Third Embodiment

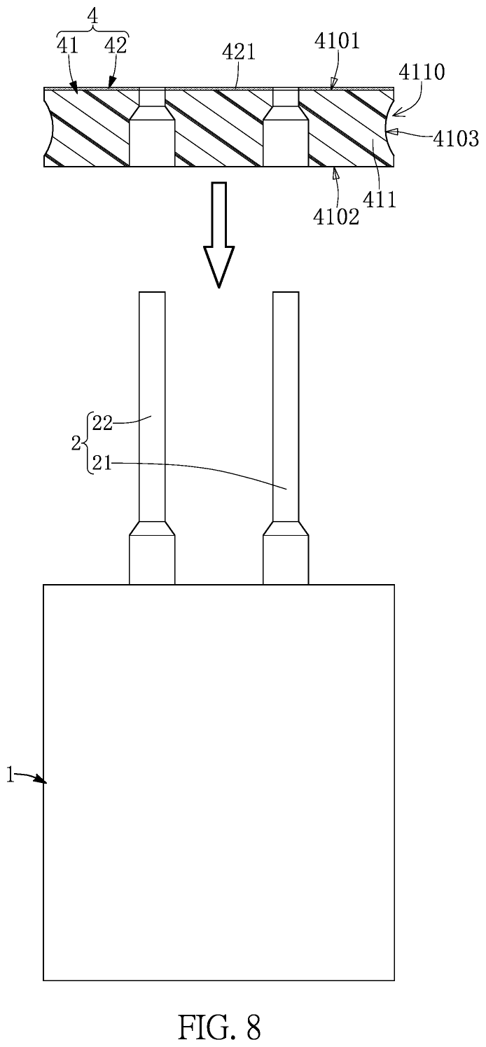

Referring to FIG. 8, a third embodiment of the present disclosure provides a sealing element 4 that can be applied to a wound capacitor package structure (not shown, but referring to the first embodiment). Comparing FIG. 8 with FIG. 2, the main difference between the third embodiment and the first embodiment is as follows: in the third embodiment, before the sealing element 4 is pressed by the surrounding concave position-limiting portion (not shown, but referring to the first embodiment), only the upper surface 4101 of the elastomeric seal structure 41 is covered by the oleophobic structural layer 421, so that the elastomeric seal structure 41 can be partially covered by the oleophobic structural layer 421, thereby preventing the upper surface 4101 of the elastomeric seal structure 41 from contacting the oil-containing cooling liquid L so as to reduce the corrosiveness of the elastomeric seal structure 41 by the oil-containing cooling liquid L.

### Fourth Embodiment

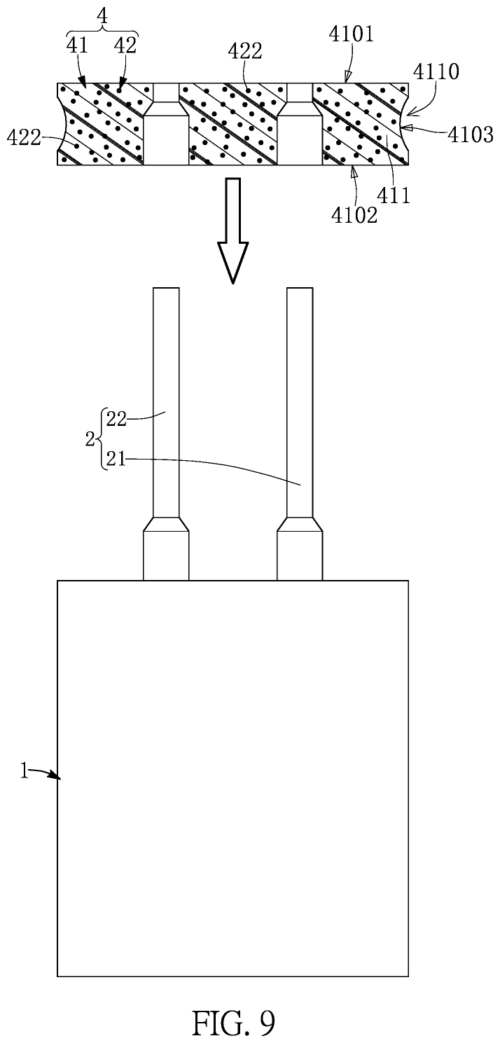

Referring to FIG. 9, a fourth embodiment of the present disclosure provides a sealing element 4 that can be applied to a wound capacitor package structure (not shown, but referring to the first embodiment). Comparing FIG. 9 with FIG. 2, the main difference between the fourth embodiment and the first embodiment is as follows: in the fourth embodiment, before the sealing element 4 is pressed by the surrounding concave position-limiting portion (not shown, but referring to the first embodiment), the oleophobic structure 42 includes a plurality of oleophobic fillers 422 each containing a predetermined oil-resistant material (such as oleophobic powder or oleophobic particles), and the oleophobic fillers 422 can be mixed into the elastomeric seal structure 41 so as to form the sealing element 4 having an oleophobic function, thereby preventing the elastomeric seal structure 41 from contacting the oil-containing cooling liquid L so as to reduce the corrosiveness of the elastomeric seal structure 41 by the oil-containing cooling liquid L.

### Fifth Embodiment

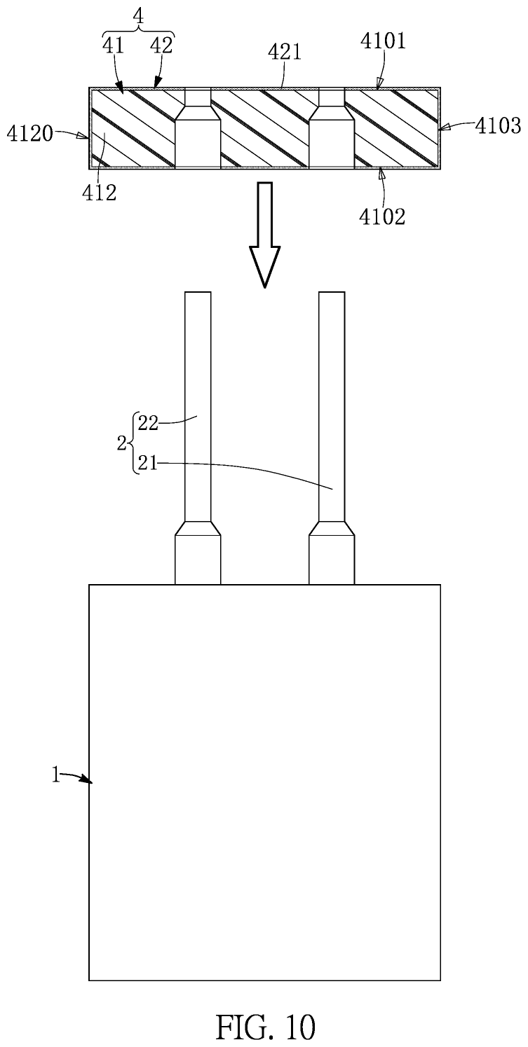

Referring to FIG. 10, a fifth embodiment of the present disclosure provides a sealing element 4 that can be applied to a wound capacitor package structure (not shown, but referring to the first embodiment). Comparing FIG. 10 with FIG. 2, the main difference between the fifth embodiment and the first embodiment is as follows: in the fifth embodiment, before the sealing element 4 is pressed by the surrounding concave position-limiting portion (not shown, but referring to the first embodiment), the elastomeric seal structure 41 of the sealing element 4 has an outer surrounding plane portion 412, and the outer surrounding plane portion 412 of the elastomeric seal structure 41 has an outer surrounding plane 4120 configured to correspond to the surrounding concave position-limiting portion (not shown, but referring to the first embodiment).

### Sixth Embodiment

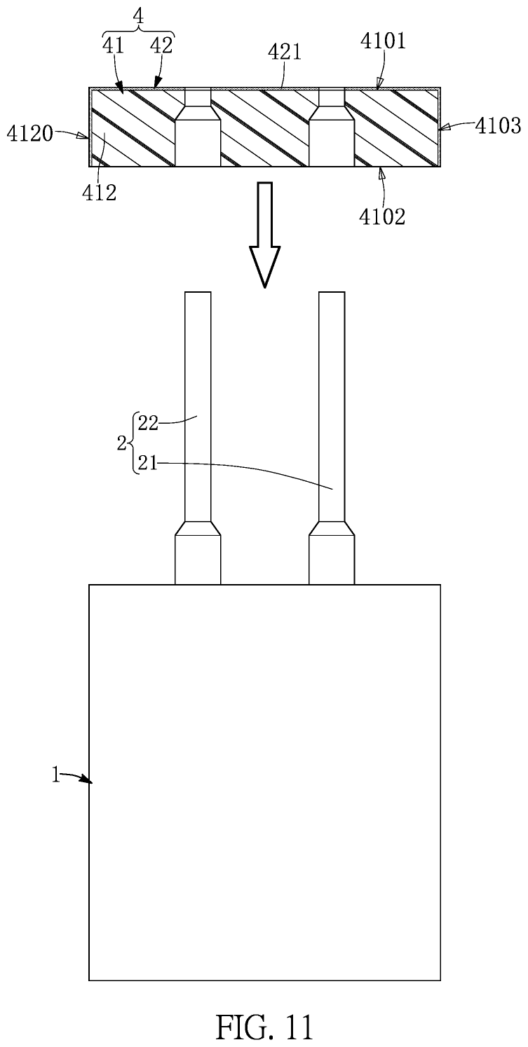

Referring to FIG. 11, a sixth embodiment of the present disclosure provides a sealing element 4 that can be applied to a wound capacitor package structure (not shown, but referring to the first embodiment). Comparing FIG. 11 with FIG. 7, the main difference between the sixth embodiment and the second embodiment is as follows: in the sixth embodiment, before the sealing element 4 is pressed by the surrounding concave position-limiting portion (not shown, but referring to the first embodiment), the elastomeric seal structure 41 of the sealing element 4 has an outer surrounding plane portion 412, and the outer surrounding plane portion 412 of the elastomeric seal structure 41 has an outer surrounding plane 4120 configured to correspond to the surrounding concave position-limiting portion (not shown, but referring to the first embodiment).

### Seventh Embodiment

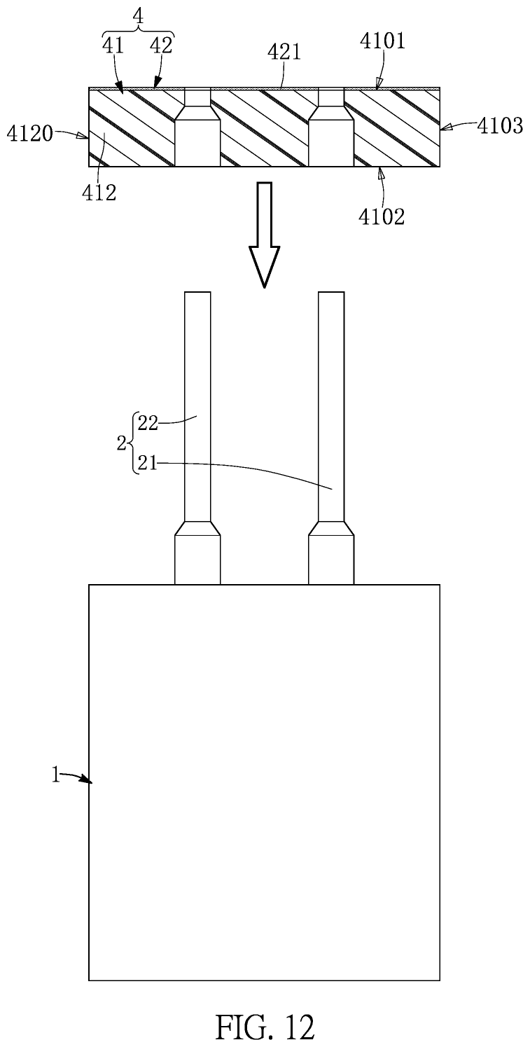

Referring to FIG. 12, a seventh embodiment of the present disclosure provides a sealing element 4 that can be applied to a wound capacitor package structure (not shown, but referring to the first embodiment). Comparing FIG. 12 with FIG. 8, the main difference between the seventh embodiment and the third embodiment is as follows: in the seventh embodiment, before the sealing element 4 is pressed by the surrounding concave position-limiting portion (not shown, but referring to the first embodiment), the elastomeric seal structure 41 of the sealing element 4 has an outer surrounding plane portion 412, and the outer surrounding plane portion 412 of the elastomeric seal structure 41 has an outer surrounding plane 4120 configured to correspond to the surrounding concave position-limiting portion (not shown, but referring to the first embodiment).

### Eighth Embodiment

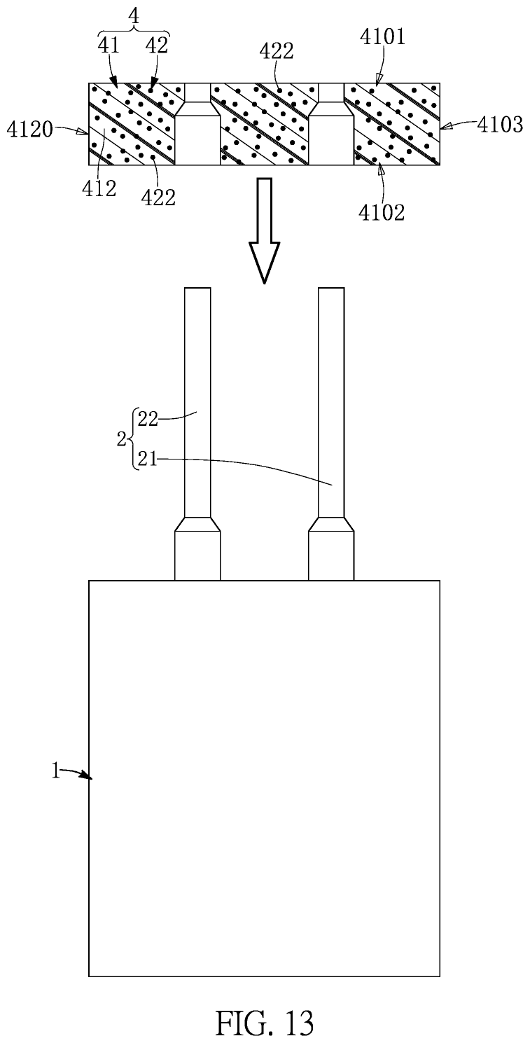

Referring to FIG. 13, an eighth embodiment of the present disclosure provides a sealing element 4 that can be applied to a wound capacitor package structure (not shown, but referring to the first embodiment). Comparing FIG. 13 with FIG. 9, the main difference between the eighth embodiment and the fourth embodiment is as follows: in the eighth embodiment, before the sealing element 4 is pressed by the surrounding concave position-limiting portion (not shown, but referring to the first embodiment), the elastomeric seal structure 41 of the sealing element 4 has an outer surrounding plane portion 412, and the outer surrounding plane portion 412 of the elastomeric seal structure 41 has an outer surrounding plane 4120 configured to correspond to the surrounding concave position-limiting portion (not shown, but referring to the first embodiment).

### Beneficial Effects of the Embodiments

In conclusion, in the wound capacitor package structure S and the sealing element 4 thereof provided by the present disclosure, by virtue of “the sealing element 4 being disposed inside the package casing 3 and cooperating with the package casing 3, and the sealing element 4 being configured to prevent the wound assembly 1 from contacting an external environment” and “the sealing element 4 including an elastomeric seal structure 41 pressed by the surrounding concave position-limiting portion 31, and an oleophobic structure 42 for protecting the elastomeric seal structure 41,” the oleophobic structure 42 of the sealing element 4 can be configured to reduce the corrosiveness of the elastomeric seal structure 41 by an oil-containing cooling liquid L.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wound capacitor package structure, comprising:
a wound assembly including a wound positive conductive foil, a wound negative conductive foil and two wound insulating separators;
a conductive assembly including a first conductive pin electrically contacting the wound positive conductive foil and a second conductive pin electrically contacting the wound negative conductive foil;
a package casing configured to receive the wound assembly; and
a sealing element disposed inside the package casing and cooperating with the package casing, wherein the sealing element is configured to prevent the wound assembly from contacting an external environment;
wherein one of the two wound insulating separators is disposed between the wound positive conductive foil and the wound negative conductive foil, and one of the wound positive conductive foil and the wound negative conductive foil is disposed between the two wound insulating separators;
wherein the first conductive pin includes a first embedded portion accommodated inside the package casing and enclosed by the sealing element, and a first exposed portion exposed outside the package casing, and the second conductive pin includes a second embedded portion accommodated inside the package casing and enclosed by the sealing element, and a second exposed portion exposed outside the package casing;
wherein the package casing has a surrounding concave position-limiting portion recessed inward to press the sealing element, and a surrounding convex end portion protruding from the surrounding concave position-limiting portion to abut against the sealing element;
wherein the sealing element includes an elastomeric seal structure pressed by the surrounding concave position-limiting portion, and an oleophobic structure for protecting the elastomeric seal structure, and the oleophobic structure of the sealing element is configured to reduce the corrosiveness of the elastomeric seal structure by an oil-containing cooling liquid.

2. The wound capacitor package structure according to claim 1,
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, and an outer surrounding surface connected between the upper surface and the lower surface, and the oleophobic structure includes an oleophobic structural layer containing a predetermined oil-resistant material;
wherein, when the upper surface, the lower surface and the outer surrounding surface of the elastomeric seal structure are covered by the oleophobic structural layer, the elastomeric seal structure is completely covered by the oleophobic structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic structural layer, the elastomeric seal structure is partially covered by the oleophobic structural layer, thereby preventing both the upper surface and the outer surrounding surface of the elastomeric seal structure from contacting the oil-containing cooling liquid;
wherein, when the upper surface of the elastomeric seal structure is covered by the oleophobic structural layer, the elastomeric seal structure is partially covered by the oleophobic structural layer, thereby preventing the upper surface of the elastomeric seal structure from contacting the oil-containing cooling liquid;
wherein, before the sealing element is pressed by the surrounding concave position-limiting portion, the elastomeric seal structure of the sealing element has an outer surrounding concave portion, the outer surrounding concave portion of the elastomeric seal structure has an outer surrounding concave space configured to accommodate a part of the surrounding concave position-limiting portion, and a concave contour of the outer surrounding concave portion of the elastomeric seal structure and a concave contour of the surrounding concave position-limiting portion of the package casing correspond to each other;
wherein, after the sealing element is pressed by the surrounding concave position-limiting portion, a large part of the outer surrounding concave portion of the elastomeric seal structure is uniformly pressed by the surrounding concave position-limiting portion, so that an outer peripheral area of the outer surrounding concave portion of the elastomeric seal structure has an approximate amount of deformation;
wherein the predetermined oil-resistant material includes polyurethane rubber, acrylate rubber, fluoro rubber or nitrile rubber, the fluoro rubber is chlorohydrin rubber, fluorosilicone rubber or fluoro-phosphazene rubber, and the nitrile rubber is hydrogenated nitrile rubber.

3. The wound capacitor package structure according to claim 1,
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, and an outer surrounding surface connected between the upper surface and the lower surface, and the oleophobic structure includes an oleophobic structural layer containing a predetermined oil-resistant material;
wherein, when the upper surface, the lower surface and the outer surrounding surface of the elastomeric seal structure are covered by the oleophobic structural layer, the elastomeric seal structure is completely covered by the oleophobic structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic structural layer, the elastomeric seal structure is partially covered by the oleophobic structural layer, thereby preventing both the upper surface and the outer surrounding surface of the elastomeric seal structure from contacting the oil-containing cooling liquid;
wherein, when the upper surface of the elastomeric seal structure is covered by the oleophobic structural layer, the elastomeric seal structure is partially covered by the oleophobic structural layer, thereby preventing the upper surface of the elastomeric seal structure from contacting the oil-containing cooling liquid;
wherein, before the sealing element is pressed by the surrounding concave position-limiting portion, the elastomeric seal structure of the sealing element has an outer surrounding plane portion, and the outer surrounding plane portion of the elastomeric seal structure has an outer surrounding plane configured to correspond to the surrounding concave position-limiting portion;
wherein the predetermined oil-resistant material includes polyurethane rubber, acrylate rubber, fluoro rubber or nitrile rubber, the fluoro rubber is chlorohydrin rubber, fluorosilicone rubber or fluoro-phosphazene rubber, and the nitrile rubber is hydrogenated nitrile rubber.

4. The wound capacitor package structure according to claim 1,
wherein the package casing has an opening, and the sealing element is configured to be disposed at the opening of the package casing so as to close the opening of the package casing;
wherein the oleophobic structure includes a plurality of oleophobic fillers each containing a predetermined oil-resistant material, and the oleophobic fillers are mixed into the elastomeric seal structure so as to form the sealing element having an oleophobic function;
wherein the predetermined oil-resistant material includes polyurethane rubber, acrylate rubber, fluoro rubber or nitrile rubber, the fluoro rubber is chlorohydrin rubber, fluorosilicone rubber or fluoro-phosphazene rubber, and the nitrile rubber is hydrogenated nitrile rubber.

5. A wound capacitor package structure, comprising:
a wound assembly;
a conductive assembly including a first conductive pin and a second conductive pin;
a package casing configured to receive the wound assembly; and
a sealing element disposed inside the package casing and cooperating with the package casing, wherein the sealing element is configured to prevent the wound assembly from contacting an external environment;
wherein the package casing has a surrounding concave position-limiting portion recessed inward to press the sealing element, and a surrounding convex end portion protruding from the surrounding concave position-limiting portion to abut against the sealing element;
wherein the sealing element includes an elastomeric seal structure pressed by the surrounding concave position-limiting portion, and an oleophobic structure for protecting the elastomeric seal structure, and the oleophobic structure of the sealing element is configured to reduce the corrosiveness of the elastomeric seal structure by an oil-containing cooling liquid.

6. The wound capacitor package structure according to claim 5,
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, and an outer surrounding surface connected between the upper surface and the lower surface, and the oleophobic structure includes an oleophobic structural layer containing a predetermined oil-resistant material;
wherein, when the upper surface, the lower surface and the outer surrounding surface of the elastomeric seal structure are covered by the oleophobic structural layer, the elastomeric seal structure is completely covered by the oleophobic structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic structural layer, the elastomeric seal structure is partially covered by the oleophobic structural layer, thereby preventing both the upper surface and the outer surrounding surface of the elastomeric seal structure from contacting the oil-containing cooling liquid;
wherein, when the upper surface of the elastomeric seal structure is covered by the oleophobic structural layer, the elastomeric seal structure is partially covered by the oleophobic structural layer, thereby preventing the upper surface of the elastomeric seal structure from contacting the oil-containing cooling liquid;
wherein, before the sealing element is pressed by the surrounding concave position-limiting portion, the elastomeric seal structure of the sealing element has an outer surrounding concave portion, the outer surrounding concave portion of the elastomeric seal structure has an outer surrounding concave space configured to accommodate a part of the surrounding concave position-limiting portion, and a concave contour of the outer surrounding concave portion of the elastomeric seal structure and a concave contour of the surrounding concave position-limiting portion of the package casing correspond to each other;
wherein, after the sealing element is pressed by the surrounding concave position-limiting portion, a large part of the outer surrounding concave portion of the elastomeric seal structure is uniformly pressed by the surrounding concave position-limiting portion, so that an outer peripheral area of the outer surrounding concave portion of the elastomeric seal structure has an approximate amount of deformation;
wherein the predetermined oil-resistant material includes polyurethane rubber, acrylate rubber, fluoro rubber or nitrile rubber, the fluoro rubber is chlorohydrin rubber, fluorosilicone rubber or fluoro-phosphazene rubber, and the nitrile rubber is hydrogenated nitrile rubber.

7. The wound capacitor package structure according to claim 5,
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, and an outer surrounding surface connected between the upper surface and the lower surface, and the oleophobic structure includes an oleophobic structural layer containing a predetermined oil-resistant material;
wherein, when the upper surface, the lower surface and the outer surrounding surface of the elastomeric seal structure are covered by the oleophobic structural layer, the elastomeric seal structure is completely covered by the oleophobic structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic structural layer, the elastomeric seal structure is partially covered by the oleophobic structural layer, thereby preventing both the upper surface and the outer surrounding surface of the elastomeric seal structure from contacting the oil-containing cooling liquid;
wherein, when the upper surface of the elastomeric seal structure is covered by the oleophobic structural layer, the elastomeric seal structure is partially covered by the oleophobic structural layer, thereby preventing the upper surface of the elastomeric seal structure from contacting the oil-containing cooling liquid;
wherein, before the sealing element is pressed by the surrounding concave position-limiting portion, the elastomeric seal structure of the sealing element has an outer surrounding plane portion, and the outer surrounding plane portion of the elastomeric seal structure has an outer surrounding plane configured to correspond to the surrounding concave position-limiting portion;
wherein the predetermined oil-resistant material includes polyurethane rubber, acrylate rubber, fluoro rubber or nitrile rubber, the fluoro rubber is chlorohydrin rubber, fluorosilicone rubber or fluoro-phosphazene rubber, and the nitrile rubber is hydrogenated nitrile rubber.

8. The wound capacitor package structure according to claim 5,
wherein the package casing has an opening, and the sealing element is configured to be disposed at the opening of the package casing so as to close the opening of the package casing;
wherein the oleophobic structure includes a plurality of oleophobic fillers each containing a predetermined oil-resistant material, and the oleophobic fillers are mixed into the elastomeric seal structure so as to form the sealing element having an oleophobic function;
wherein the predetermined oil-resistant material includes polyurethane rubber, acrylate rubber, fluoro rubber or nitrile rubber, the fluoro rubber is chlorohydrin rubber, fluorosilicone rubber or fluoro-phosphazene rubber, and the nitrile rubber is hydrogenated nitrile rubber.

9. A sealing element applied to a wound capacitor package structure including a wound assembly, a conductive assembly and a package casing;
wherein the sealing element is disposed inside the package casing and cooperating with the package casing, and the sealing element is configured to prevent the wound assembly from contacting an external environment;
wherein the package casing has a surrounding concave position-limiting portion recessed inward to press the sealing element, and a surrounding convex end portion protruding from the surrounding concave position-limiting portion to abut against the sealing element;
wherein the sealing element includes an elastomeric seal structure pressed by the surrounding concave position-limiting portion, and an oleophobic structure for protecting the elastomeric seal structure, and the oleophobic structure of the sealing element is configured to reduce the corrosiveness of the elastomeric seal structure by an oil-containing cooling liquid.

10. The sealing element according to claim 9,
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, and an outer surrounding surface connected between the upper surface and the lower surface, and the oleophobic structure includes an oleophobic structural layer containing a predetermined oil-resistant material;
wherein, when the upper surface, the lower surface and the outer surrounding surface of the elastomeric seal structure are covered by the oleophobic structural layer, the elastomeric seal structure is completely covered by the oleophobic structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic structural layer, the elastomeric seal structure is partially covered by the oleophobic structural layer, thereby preventing both the upper surface and the outer surrounding surface of the elastomeric seal structure from contacting the oil-containing cooling liquid;
wherein, when the upper surface of the elastomeric seal structure is covered by the oleophobic structural layer, the elastomeric seal structure is partially covered by the oleophobic structural layer, thereby preventing the upper surface of the elastomeric seal structure from contacting the oil-containing cooling liquid;
wherein, before the sealing element is pressed by the surrounding concave position-limiting portion, the elastomeric seal structure of the sealing element has an outer surrounding concave portion, the outer surrounding concave portion of the elastomeric seal structure has an outer surrounding concave space configured to accommodate a part of the surrounding concave position-limiting portion, and a concave contour of the outer surrounding concave portion of the elastomeric seal structure and a concave contour of the surrounding concave position-limiting portion of the package casing correspond to each other;
wherein, after the sealing element is pressed by the surrounding concave position-limiting portion, a large part of the outer surrounding concave portion of the elastomeric seal structure is uniformly pressed by the surrounding concave position-limiting portion, so that an outer peripheral area of the outer surrounding concave portion of the elastomeric seal structure has an approximate amount of deformation;
wherein the predetermined oil-resistant material includes polyurethane rubber, acrylate rubber, fluoro rubber or nitrile rubber, the fluoro rubber is chlorohydrin rubber, fluorosilicone rubber or fluoro-phosphazene rubber, and the nitrile rubber is hydrogenated nitrile rubber.
